(19) United States
(12) Patent Application Publication
(10) Pub. No.: US 2008/0177664 A1
(43) Pub. Date: Jul. 24, 2008

(54) Measurement data accuracy validation key

(76) Inventor: Steve Vazzano, Glen Ellyn, IL (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/655,387

(22) Filed: Jan. 19, 2007

(51) Int. Cl. H04L 9/00

(52) U.S. Cl. 705/50

(57) ABSTRACT

Shippers can provide shipment data that may be inaccurate. A third party verifier can independently verify the physical attributes of a shipment and can append digital verification information to the forms used by the sender and recipient to exchange physical attribute data. A validation key added by the third party verifier can comprise a check digit which can, in combination with a published algorithm, be used to verify the associated physical attribute data. The validation key can also comprise another check digit which can, in combination with a private algorithm known only by the third party verifier, be used to further verify the associated physical attribute data.

### BACKGROUND

In many industries, and especially in the consumer goods industry, it is important for retailers to know the attributes of goods before they arrive. For example, the physical dimensions of goods provided in advance can be used to ensure that sufficient space is available to receive the goods. Alternatively, the ingredients of a product provided in advance can be used to ensure that the product conforms with the goal of the retailer, such as ensuring that products sold by a retailer catering to vegetarians do not contain animal products. Consequently, various mechanisms have evolved by which suppliers or shippers can provide relevant attributes of products to the recipients, such as retailers, prior to the delivery of those products. Some of these mechanisms are standardized across an industry, while other can be proprietary or recipient-specific.

Often, the mechanisms by which the attributes of products are provided to recipients, such as retailers, involve digital forms or structures designed to enable the recipient's computing systems to efficiently receive and parse the attribute data. For example, the ubiquitous eXtensible Markup Language (XML) is often used to create an XML data structure that can transmit the attributes of products from the sender to a recipient. In such a case, the sender, such as a supplier or shipper, can enter the relevant attributes of the product, together with an identifier for that product, or that particular shipment of the product, into an XML data structure and electronically transmit the XML data structure to the recipient. The recipient can then parse the XML data structure to obtain the attribute data, and can use the obtained data as input in to the recipient's own databases or other back-end processes, to verify that the product conforms to the needs, requirements or expectations of the recipient.

### SUMMARY

Because suppliers can provide thousands of shipments to even a single recipient, the process of entering the attribute data of each product, or even each shipment of a product, is generally automated, often by assuming that the attributes do not change over time. While such an assumption may be valid over a short period of time, suppliers often do not update the attribute data even after the underlying product or packaging has changed. For example, the packaging for many products may become smaller and lighter as manufacturers seek to save shipping and packaging costs. A supplier or shipper that does not update the attribute data of the shipment will end up sending shipments that, while comprising the same elements will, because of a change in the packaging, be lighter and smaller than the reported physical attributes. Such inaccuracies can result in storage inefficiencies at the recipient and can damage business relationships between the sender and recipient.

A third party verifier can independently verify the attributes of some or all of the products or shipments of products being sent to a recipient, and can append digital verification information to the forms used by the sender and recipient to exchange attribute data. For example, if attribute data is exchanged using XML data structure, the third party verifier can append XML fields which can be used by the recipient or the third party verifier to digitally prove that the attribute information contained within the XML data structure was verified by the third party verifier. In one embodiment, a validation key added by the third party verifier can comprise a check digit which can, in combination with a published algorithm, be used to verify the associated physical attribute data. In another embodiment, a validation key added by the third party verifier can comprise an identifier by which the receiver can select an appropriate published algorithm, from among a plurality of published algorithms, with which to verify the associated attribute data using the associated check digit. In a still further embodiment, a validation key added by the third party verifier can comprise another check digit which can, in combination with a private algorithm known only by the third party verifier, be used to verify the associated attribute data.

A third party verifier can independently measure, test, observe, or otherwise verify the attributes of a product or shipment, either prior to the departure of the shipment from the sender or during the transportation of the shipment to the recipient. A data structure comprising the attribute data can, likewise, either be verified prior to transmission by the sender to the recipient, or the data structure can be sent by the sender directly to the third party verifier in order to enable the third party verifier to append the appropriate information prior to forwarding the data structure on to the recipient.

Once received, the validation key added by the third party verifier can be used by the recipient to establish that the associated attribute data has been double-checked by the third party verifier. In one embodiment, the recipient can identify the published algorithm used via an identifier in the validation key and, using the same algorithm, can obtain a check digit using the attribute data as inputs into the algorithm. If the check digit calculated by the recipient is equal to the public check digit stored by the third party verifier in the validation key, the recipient can determine that the attribute data was verified by the third party verifier. In another embodiment, if the recipient desires further verification, it can contact the third party verifier and the third party verifier can use a private algorithm, with the attribute data as inputs, to calculate a private check digit. If this private check digit is equal to the private check digit from the validation key, the third party verifier can determine that the validation key was not forged. However, if they are not equal, the third party verifier can determine that the validation key is improper and that the associated attribute data is not, therefore, verified.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a system diagram of an exemplary commercial transaction using a third party verifier;

FIG. 2 is a diagram of an exemplary data structure and its population;

FIG. 3 is block diagram of an exemplary computing device;

FIG. 4 is a flow chart illustrating an exemplary mechanism of verifying the attribute data of a shipment; and

FIG. 5 is a flow chart illustrating a further exemplary mechanism of verifying the attribute data of a shipment.

### DETAILED DESCRIPTION

The following description relates to providing independent verification of the reported attribute data of a product or a shipment of one or more products. A third party verifier can independently measure, observe, test, or otherwise verify the physical attribute data of a product or a shipment of the product and can generate a validation key that can be appended to an electronic form or data structure used to transmit the attribute data to a recipient. In one embodiment the validation key can comprise a check digit. In another embodiment, the validation key can further comprise an identifier of the published algorithm used to generate the check digit. In a still further embodiment, the validation key can further comprise a private check digit, generated by a private algorithm, that can be used for additional verification.

The techniques described herein focus on the generation of the public and private check digits, the generation of the validation key, and the use of the validation key by the recipient to verify the attribute data associated therewith. Although not required, the descriptions below will be in the general context of computer-executable instructions, such as program modules, being executed by one or more computing devices. More specifically, the descriptions will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing devices, as the mechanisms may also be practiced in distributed computing environments where tasks are performed by remote processing devices that are linked through a communications network. In a distributed computing environment, program modules may be located in both local and remote memory storage devices.

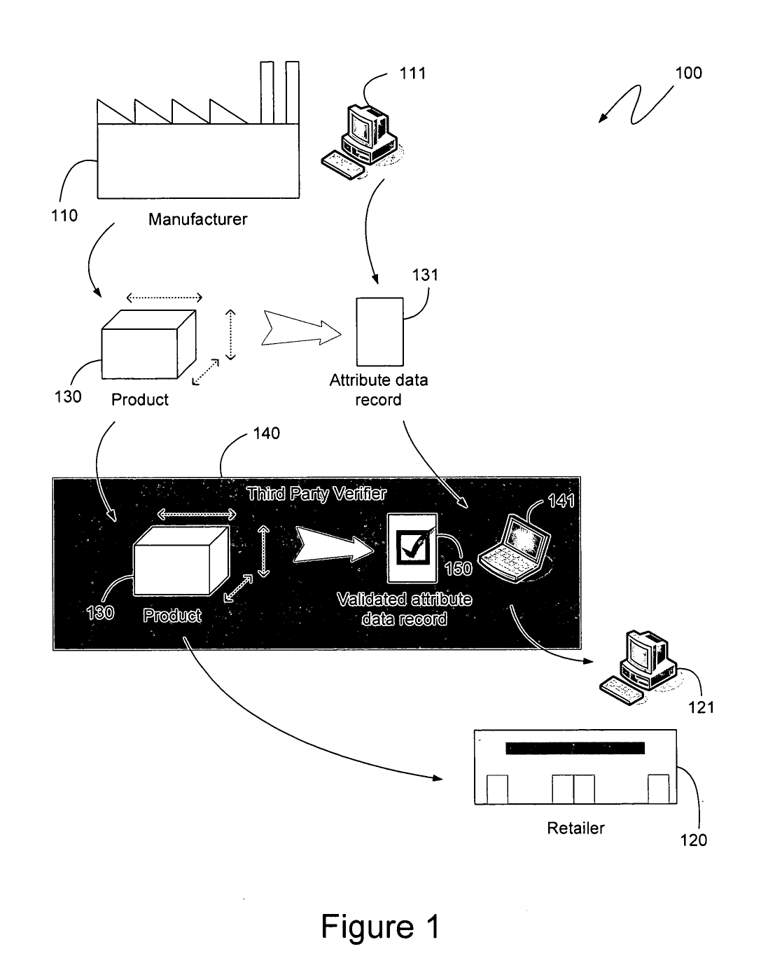

Turning to FIG. 1, an exemplary transactional system 100 is illustrated comprising, in part, a retailer 120, and a manufacturer 110, though, as will be clear from the foregoing descriptions, any the retailer and manufacturer can be any recipient and sender, respectively. System 100 of FIG. 1 further comprises the shipment of a product 130 from the manufacturer 110 to the retailer 120, and an associated attribute data record 131.

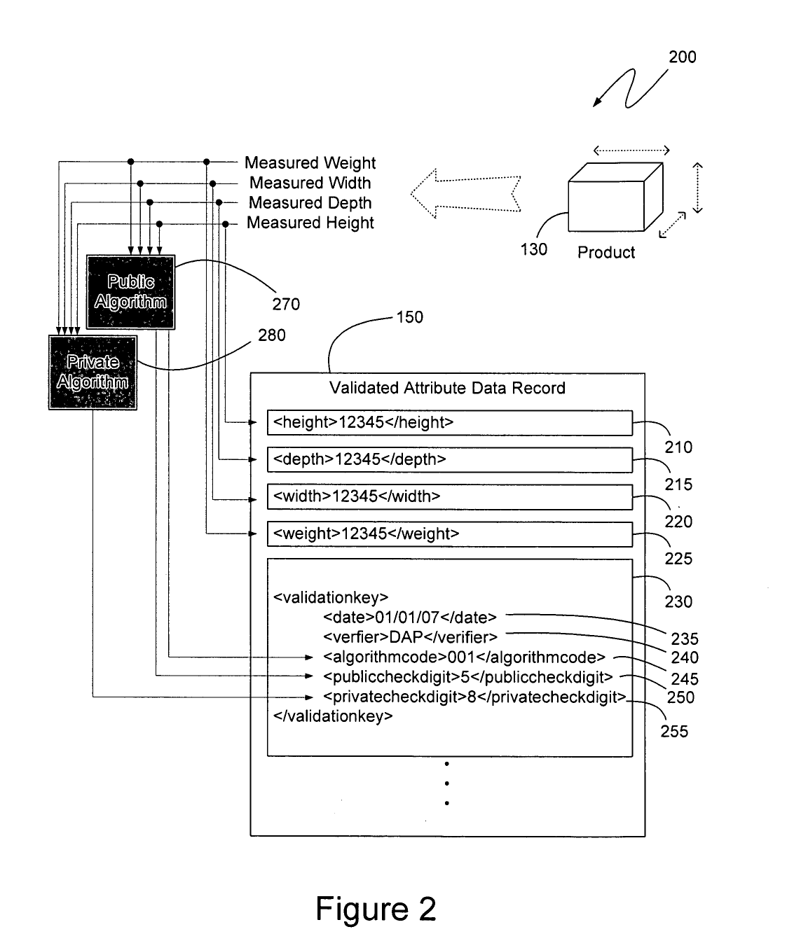

Upon creating the product 130, the manufacturer can likewise create an attribute data record 131 comprising the attributes of the product, in addition to other information such as an identifier of the shipment of the product. Such a record 131 can be in electronic form, such as would have been created or edited by the computing device 111, associated with the manufacturer 110. FIG. 2, described further below, illustrates such an attribute data record implemented using the eXtensible Markup Language (XML).

To more efficiently generate the attribute data record 131, the manufacturer 110 may not observe, test and measure each product 130, but may instead use a series of expected values that are, generally, very close to the actual attributes of a specific product, such as product 130. Over time, however, as the product 130, evolves, such expected values may deviate significantly from the true attributes of the product 130.

In one embodiment, a third party verifier 140 can be used to provide independent verification of the attributes of the product 130 as reported by the associated attribute data record 131. The third party verifier 140 can use a computing device 141 to receive the attribute data record 131 and append to it a validation key, resulting in a validated attribute data record 150. The third party verifier 140, or, more particularly, the computing device 141 can then transmit the validated attribute data record 150 to the retailer 120, or, more specifically, to the computing device 121 associated with the retailer. The retailer 120 can likewise receive the associated product 130. In an alternative embodiment, not illustrated in FIG. 1, the third party verifier 140 can work in conjunction with the manufacturer 110 such that the validated attribute data record 150 is sent from the manufacturer 110 to the retailer 120 directly, or, more specifically, from the computing device 111 associated with the manufacturer 110 to the computing device 121 associated with the retailer 120.

The third party verifier 140 can independently acquire the attributes of the product 130 and can use such independently acquired data to generate the validated attribute data record 150. FIG. 2 illustrates an exemplary validated attribute data record 150 and a method of generating it.

As can be seen, the third party verifier 140 can independently acquire the attributes of the product 130. In one embodiment, the third party verifier 140 can be co-located with the manufacturer 110 such that only a single measurement, test or observation of the relevant attributes of the product 130 is performed. In such a case, the third party verifier 140 can provide the validation information to the manufacturer 110, including a validation key and an identification of the algorithm used. The manufacturer 110 can then send the validated attribute data record 150, comprising this validation information, to the retailer 120. In an alternative embodiment, the third party verifier 140 can receive the product 130 as part of its route to the retailer 120, or as an independent test kit, and can perform its own tests, measurements or observations of the relevant attributes. In such a case, the validated attribute data record 150 can be transmitted to the retailer 120 by the third party verifier 140.

In either event, once obtained, the attributes of the shipment 130 can be stored within the appropriate fields of the validated attribute data record 150. For example, as shown in FIG. 2, the attributes of the product 130 can comprise a measured weight as well as measured dimensional attributes, such as width, depth and height. The validated attribute data record 150 is shown comprising XML fields, such as the height field 210, the depth field 215, the width field 220 and the weight field 225, each identified by their respective XML tags, such as would be defined in an appropriate XML schema in a manner well known to those skilled in the art.

The product attributes illustrated in FIG. 2 are meant to be exemplary only, and nothing in the present application is meant to be limiting with respect to the nature of the product attribute data. For example, the product attributed verified by the third party verifier 140 can include ingredient or component data. The product 130 could, for example, comprise a unit of furniture that requires assembly. In such a case, the product attributes verified by the third party verifier 140 can include the number of screws, nails, and bolts included in the product 130. Consequently, the data being entered into fields, such as fields 210 through 225 of the validated attribute data record 150, can comprise fastener quantities.

In addition, nothing in the present application is meant to limit product attribute data to numerical values. For example, the product attributed verified by the third party verifier 140 can include ingredient or component names. If the product 130, for example, is a box of crayons, the product attributes verified by the third party verifier 140 can include names of the colors of the crayons included in the product 130. Consequently, the data being entered into fields, such as fields 210 through 225 of the validated attribute data record 150, can comprise alphanumeric characters, which can be translated to numerical values by any one of a number of established mechanisms well known to those of skill in the art.

In addition to entering the measured, tested, or observed, attributes into their respective fields within the validated attribute data record 150, those attributes can also serve as inputs into a public algorithm 270 and, optionally, a private algorithm 280. The public algorithm 270 can be any mathematical algorithm that can compute a check digit based on the input attribute data. The public algorithm 270 can be as simple as a summation algorithm, or can be a more complex check-digit generation algorithm such as those used for error correction or data encryption. Additionally, while the check digit generated may be a single decimal or hexadecimal digit, the term “check digit” is not meant to imply such limitation and the generated check digit may, in fact, be quite large.

The public algorithm 270 can output, not only the check digit itself, but also an identifier of the algorithm used. Such information can be stored within the appropriate sections of the validation key 230, such as the XML sub-fields 245 and 250, respectively, as shown in FIG. 2. The validation key 230 can further comprise a date sub-field 235, to identify the date when the third party verifier 140 independently measured the attributes of the product 130, and a verifier sub-field 240, to identify the third party verifier itself.

Like the public algorithm 270, the private algorithm 280 can also accept, as input, the measured, tested, or observed, attributes of the product 130 and output a check digit. Because the public algorithm 270 can be shared with the recipient of the validated attribute data record 150, to enable the recipient to verify that the attribute data record 150 was, actually, validated, the private algorithm 280 can, for increased security, be different from the public algorithm. However, the private algorithm 280 can, like the public algorithm 270, be a fairly simple addition-based algorithm, or it can be a more complex check-digit generation algorithm, such as those used for error correction or digital encryption.

The check digit generated by the private algorithm 280 can be, likewise, stored as part of the validation key 230, such as in the private check digit XML sub-field 255 illustrated in FIG. 2. While the validation key 230 is illustrated in FIG. 2 as comprising sub-fields 235 through 255, the validation key is not so limited, and can comprise any information useful for validating the measured, or observed, physical attributes of the shipment 130. Likewise, and as indicated previously, while the validated attribute data record 150 is illustrated in FIG. 2 as comprising height, weight, depth and weight information, the validated shipment record is not so limited, and can comprise any other measurable, observable, or identifiable data of the product 130.

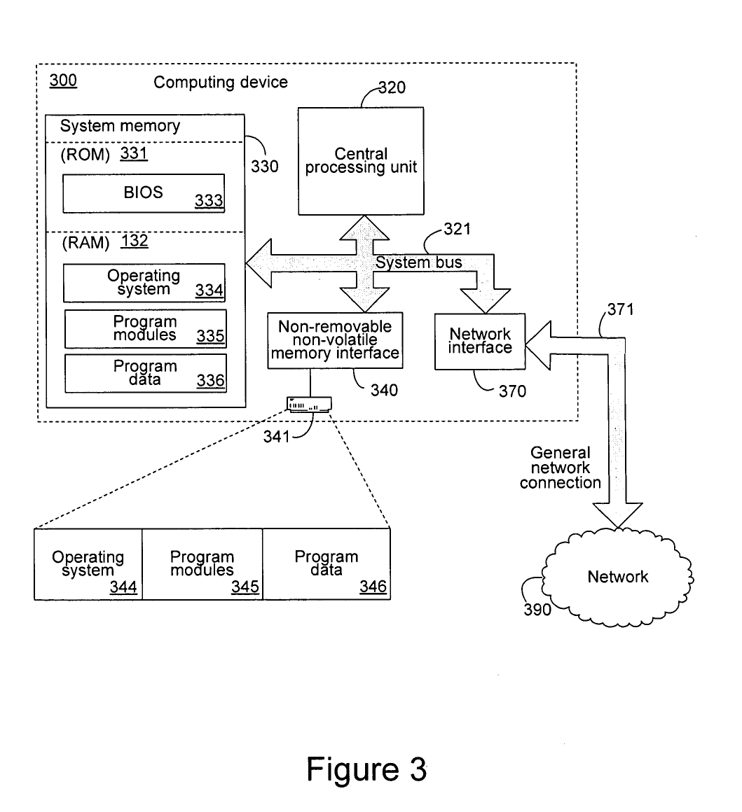

Turning to FIG. 3, an exemplary computing device 300 is illustrated. The exemplary computing device 300 can represent any or all of the computing devices illustrated as part of system 100, such as computing devices 111, 121 or 141. The exemplary computing device 300 can include, but is not limited to, one or more central processing units (CPUs) 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures.

The computing device 300 also typically includes computer readable media, which can include any available media that can be accessed by computing device 300 and includes both volatile and nonvolatile media and removable and non-removable media. By way of example, and not limitation, computer readable media may comprise computer storage media, communication media or combinations thereof. Computer storage media includes media implemented in any method or technology for storage of information such as computer readable instructions, data structures, program modules or other data. Communication media typically embodies computer readable instructions, data structures, program modules or other data in a modulated data signal such as a carrier wave or other transport mechanism and includes any information delivery media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computing device 300, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, other program modules 335, and program data 336.

The computing device 300 may also include other removable/non-removable, volatile/nonvolatile computer storage media. By way of example only, FIG. 3 illustrates a hard disk drive 341 that reads from or writes to nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 341 is typically connected to the system bus 321 through an interface such as non-volatile memory interface 340.

The drives and their associated computer storage media discussed above and illustrated in FIG. 3, provide storage of computer readable instructions, data structures, program modules and other data for the computing device 300. In FIG. 3, for example, hard disk drive 341 is illustrated as storing operating system 344, other program modules 345, and program data 346. Note that these components can either be the same as or different from operating system 334, other program modules 335 and program data 336. Operating system 344, other program modules 345 and program data 346 are given different numbers hereto illustrate that, at a minimum, they are different copies.

Of relevance to the descriptions below, the computing device 300 may operate in a networked environment using logical connections to one or more remote computers. For simplicity of illustration, the computing device 300 is shown in FIG. 3 to be connected to the network 390. The computing device 300 is not limited to any particular network or networking protocols. The general network connection 371 depicted is a general network connection that can be a connection to a local area network (LAN), a wide area network (WAN) or other networks. The computing device 300 is connected to the general network connection 371 through a network interface or adapter 370 which is, in turn, connected to the system bus 321. In a networked environment, program modules depicted relative to the computing device 300, or portions or peripherals thereof, may be stored in the memory of one or more other computing devices that are communicatively coupled to the computing device 300 through the general network connection 371. It will be appreciated that the network connections shown are exemplary and other means of establishing a communications link between computing devices may be used.

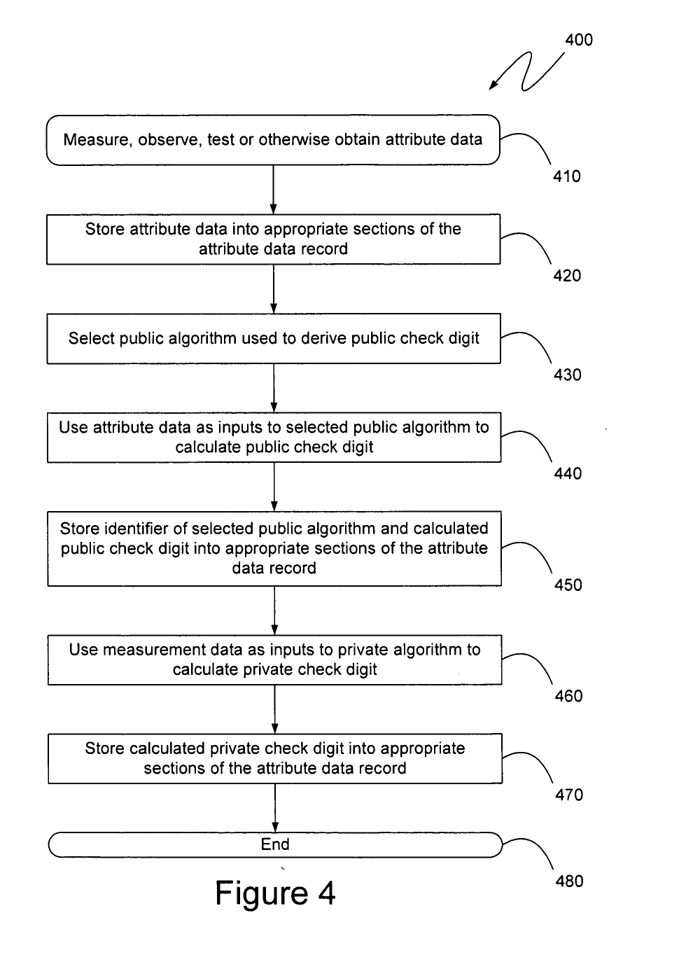

FIG. 4 illustrates a flow diagram 400, providing an illustration of an exemplary series of steps by which an attribute data record 131 can be validated by a third party verifier 140. As shown in FIG. 4, flow diagram 400 begins with the measurement, testing observation, or other acquisition of attribute data at step 410. Subsequently, at step 420, the attribute data is stored into the appropriate fields of the attribute data record, such as in the manner shown in FIG. 2. Once stored, a public algorithm can be selected at step 430 by which a public check digit can be derived. At step 440, the public check digit is derived, based on the attribute data obtained at step 410, optionally in combination with other data, as input into the public algorithm selected at step 430. After the public check digit is calculated, it can be added to the attribute data record at step 450. In one embodiment, the public check digit can be added to a sub-field of a validation key, such as validation key 230 illustrated in FIG. 2.

In addition to the public check digit, an identification of the algorithm used to generate the public check digit can likewise be added to the attribute data record at step 450. As will be described in more detail below, such an identification can enable the recipient to verify the public check digit and thereby verify that the third party verifier 140 did, in fact, confirm the information contained in the validated attribute data record 150.

Flow diagram 400 of FIG. 4 further comprises steps 460 and 470 which, in one embodiment, are optional. As shown, at step 460, a second check digit can be calculated. Such a second check digit can be based on a private algorithm known only to the third party verifier 140 and used to determine whether the validation of the attribute data record 131 is fraudulent. The private algorithm can, like the public algorithm, use the attribute data obtained at step 410 as inputs to generate the private check digit. Subsequently, at step 470, the calculated private check digit can be stored in the attribute data record. In one embodiment, the private check digit can be stored in a sub-field of a validation key 230, as shown in FIG. 2. The validation of the attribute data record by the flow diagram 400 then ends at step 480 as shown in FIG. 4.

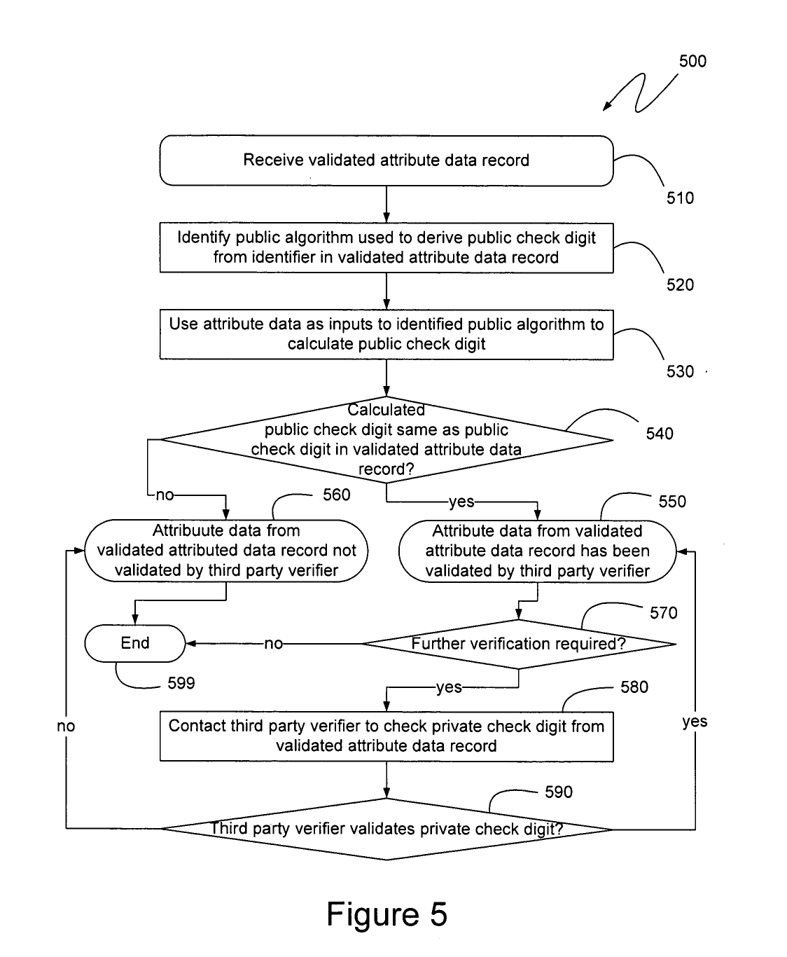

Turning to FIG. 5, a flow diagram 500 illustrates an exemplary mechanism by which the data generated by flow diagram 400 of FIG. 4 can be used by a recipient to verify the validation of the attribute data record. Initially, flow diagram 500 begins at step 510 when the validated attribute data record 150 is received, such as by the retailer 120 or, more specifically, a computing device 121 associated with the retailer. Subsequently, the identifier of the algorithm used to calculate the public check digit can be located and used to select the same algorithm at step 520. Using the same input data, at step 530, the recipient can itself calculate the public check digit that was calculated by the third party verifier 140 at step 440 of FIG. 4. In one embodiment, a series of various algorithms used to calculate check digits, such as the algorithms referenced above, can be exchanged in advance between the third party verifier 140 and recipients, such as the retailer 120. In an alternative embodiment, the third party verifier 140 can provide a “key” associating various algorithms for calculating check digits with various identifiers. Such a key can be transmitted along with the validated attribute data record 150, can be transmitted independently, or it can be hosted in a common location, such as a web site, whereby any recipient with the appropriate credentials can access the information. In a still further alternative embodiment, the key associating identifiers with the algorithms for calculating check digits can be generated and hosted, or sent, by an independent party which is not affiliated with either recipients or with the third party verifier 140.

Once the recipient has calculated the check digit using the identified algorithm and the appropriate data as input, as illustrated by step 530, the recipient can, at step 540, check whether the check digit calculated matches the public check digit stored in the validated attribute data record 150. If the two check digits are not equivalent, then the recipient can conclude, as shown by step 560, that the measurement, observation or identifying data contained in the attribute data shipment record 150 has not, in fact, been validated by the third party verifier 140. However, if the check digit calculated by the recipient matches the public check digit from the validated attribute data record 150, then, at step 550, the recipient can conclude that the measurement, observation or identifying data contained in the validated attribute data record 150 has, in fact, been validated by the third party verifier 140.

If the recipient concludes that the shipment record was not properly validated at step 560, the processing can then end at step 599. However, if the recipient concludes that the attribute data record was properly validated, because the public check digit matches the check digit independently computed by the recipient, the recipient can still determine, at step 570, whether additional verification is required. For example, the recipient may have reason to suspect the validated attribute data record 150, or it may be critically important to the recipient that the data contained within the validated shipment record be accurate. If no further verification is required at step 570, then the processing performed by the recipient can end at step 599. If, however, it is determined, at step 570, that additional verification is required, the recipient can, at step 580, contact the third party verifier 140 to request that the third party verifier check the private check digit from the validated attribute data record 150.

Because the public check digit is based on an algorithm that is known, via the identifier 245 in the validated attribute data record 150, an untrusted party can generate a “validated attribute data record” comprising data and a public check digit for that data using one of the known public algorithms. In such a case, the data in the shipment record would appear to be validated even though it was not, in fact, validated by a trusted third party verifier. However, the private check digit, calculated by an algorithm known only to the trusted third party verifier, can serve to double-check the claimed “validation” of the data contained within the attribute data record 131.

Thus, at step 580, the recipient can contact the third party verifier 140 and provide the data from the attribute data record, and the third party verifier can, using a private algorithm, calculate a private check digit, which can subsequently be communicated back to the recipient. At step 590, the recipient can determine whether the third party verifier 140 has validated the private check digit, either by comparing the received private check digit to the private check digit contained within the validated attribute data record 150, or by sending the private check digit from the validated attribute data record to the third party verifier together with the data from the attribute data record, and requesting that the third party verifier to compare the two check digits.

The private check digit contained within the validated attribute data record 150 can be validated at step 490 if it is the same as the private check digit calculated by the third party verifier 140 using the data from the validated attribute data record, which was sent at step 580. If the private check digit was validated at step 590, the recipient can conclude, at step 550, that the attribute data from the validated attribute data record 150 was, in fact, validated by the third party verifier 140. Subsequently, because no further verification would now be required at step 570, the processing can end at step 599. However, if the private check digit was not validated at step 590, the recipient can conclude, at step 560, that the attribute data from the validated shipment record 150 was not, in fact, validated by the third party verifier 140, despite having a valid public check digit. The processing can then end at step 599.

As can be seen from the above descriptions, a third party verifier can be used to validate attribute data records comprising attributes of one or more products. In view of the many possible variations of the subject matter described herein, we claim as our invention all such embodiments as may come within the scope of the following claims and equivalents thereto.

We claim:

1. One or more computer-readable media comprising computer-executable instructions for validating an attribute data record corresponding to a product, the computer-executable instructions directed to steps comprising:
receiving data regarding the product;
storing the data in the attribute data record;
selecting a public algorithm for deriving a public check digit;
using the selected public algorithm and at least some of the data regarding the product to calculate the public check digit;
storing the public check digit in the attribute data record; and
storing an identifier of the selected public algorithm in the attribute data record.

2. The computer-readable media of claim 1, wherein the validation of the attribute data record is verified by independently calculating the public check digit using the at least some of the data regarding the product and the selected public algorithm, as identified by the identifier of the selected public algorithm, and comparing the independently calculated public check digit with the public check digit stored in the attribute data record.

3. The computer-readable media of claim 1, comprising further computer-executable instructions directed to:
selecting a private algorithm, different from the public algorithm, for deriving a private check digit;
using the selected private algorithm and at least some of the data regarding the product to calculate the private check digit; and
storing the private check digit in the attribute data record.

4. The computer-readable media of claim 3, wherein the validation of the attribute data record is verified by requesting external confirmation of the private check digit given the at least some of the data regarding the product.

5. The computer-readable media of claim 1, wherein the data regarding the product comprises data representing physical attributes of the product.

6. The computer-readable media of claim 1, wherein the selected public algorithm is selected from a pre-defined list of public algorithms and corresponding identifiers.

7. A validation key for validating an attribute data record associated with a product, the validation key comprising:
an identifier of a third party verifier generating the validation key
a public algorithm identifier associated with a public algorithm for generating a check digit from data contained in the attribute data record; and
a public check digit computed by the third party verifier using the public algorithm and data contained in the attribute data record.

8. The validation key of claim 7, wherein the validation of the attribute data record is verified by independently calculating the public check digit using the data contained in the attribute data record and the selected public algorithm, as identified by the public algorithm identifier, and comparing the independently calculated public check digit with the public check digit of the validation key.

9. The validation key of claim 7, further comprising a private check digit computed by the third party verifier using a private algorithm, different from the public algorithm, and data contained in the attribute data record.

10. The validation key of claim 9, wherein the validation of the attribute data record is verified by requesting external confirmation of the private check digit given the data contained in the attribute data record.

11. The validation key of claim 7, wherein the attribute data record comprises data representing physical attributes of the product.

12. The validation key of claim 7, wherein the public algorithm is selected from a pre-defined list of public algorithms and corresponding public algorithm identifiers.

13. The validation key of claim 7 formatted using XML.

14. A method of validating an attribute data record corresponding to a product, the method comprising the steps of:
receiving data regarding the product;
storing the data in the attribute data record;
selecting a public algorithm for deriving a public check digit;
using the selected public algorithm and at least some of the data regarding the product to calculate the public check digit;
storing the public check digit in the attribute data record; and
storing an identifier of the selected public algorithm in the attribute data record.

15. The method of claim 14, wherein the validation of the attribute data record is verified by independently calculating the public check digit using the at least some of the data regarding the product and the selected public algorithm, as identified by the identifier of the selected public algorithm, and comparing the independently calculated public check digit with the public check digit stored in the attribute data record.

16. The method of claim 14, further comprising the steps of:
selecting a private algorithm, different from the public algorithm, for deriving a private check digit;
using the selected private algorithm and at least some of the data regarding the product to calculate the private check digit; and
storing the private check digit in the attribute data record.

17. The method of claim 16, wherein the validation of the attribute data record is verified by requesting external confirmation of the private check digit given the at least some of the data regarding the product.

18. The method of claim 14, wherein the data regarding the product comprises data representing physical attributes of the product.

19. The method of claim 14, wherein the selected public algorithm is selected from a pre-defined list of public algorithms and corresponding identifiers.

20. The method of claim 19, further comprising the steps of publishing the pre-defined list of public algorithms and corresponding identifiers.
